(19) United States
(12) Patent Application Publication
(10) Pub. No.: US 2021/0320452 A1
(43) Pub. Date: Oct. 14, 2021

(54) CONNECTOR UNIT AND CONNECTOR

(71) Applicant: Yazaki Corporation, Tokyo (JP)

(72) Inventors: Katsuya NAKANO, Kakegawa-shi (JP); Takashi SONE, Kakegawa-shi (JP); Yoshinori HAGITA, Kakegawa-shi (JP)

(73) Assignee: Yazaki Corporation, Tokyo (JP)

(21) Appl. No.: 17/204,407

(22) Filed: Mar. 17, 2021

(30) Foreign Application Priority Data
Apr. 9, 2020 (JP) 2020-070399

(51) Int. Cl. H01R 13/52

(52) U.S. Cl. CPC H01R 13/5202

(57) ABSTRACT

A connector unit includes a first and second housings and a seal member. The second housing includes a groove portion and a protruding portion having an outer circumferential surface. The groove portion includes a bottom surface, a first side wall and a second side wall. The protruding portion extends from the second side wall toward the first side wall. The outer circumferential surface has an inclined surface inclined such that an end thereof is closer to the bottom surface than another end. When the first housing and the second housing are attached to each other, an end portion of the first housing face the outer circumferential surface. The seal member includes an engaging portion to engage with the protruding portion to prevent the seal member from moving in a circumferential direction with respect to the second housing.

### CROSS-REFERENCE TO RELATED APPLICATION

The present application claims priority to Japanese Patent Application No. 2020-070399 filed on Apr. 9, 2020, the entire content of which is incorporated herein by reference.

### TECHNICAL FIELD

The present invention relates to a connector unit and a connector.

### BACKGROUND

A related art connector has a waterproof function. For example, the connector is configured such that a ring-shaped seal member is provided between an outer circumferential surface of the connector that holds a plurality of wire-side terminals and an inner circumferential surface of a fitting opening of a counterpart connector. The ring-shaped seal member prevents water from entering fitting portions of the connectors (for example, see JP2004-172009A).

In the above-described connector, in order to prevent the seal member from moving so as to rotate in a circumferential direction of the connector (that is, occurrence of rotational deviation), a protrusion or the like is provided on a housing to be engaged with the seal member to restrict rotation of the seal member. However, when such a protrusion is provided on the housing, the seal member may be deformed and get/ride on the protrusion or the like due to a frictional force or the like exerted by the inner circumferential surface of the fitting opening of the counterpart connector which pushes the seal member in a fitting direction in which the two connectors are fitted to each other. In this case, the seal member riding on the protrusion or the like may hinder the fitting of the connectors themselves.

### SUMMARY

Illustrative aspects of the present invention provide a connector unit and a connector configured to enable proper connector fitting while preventing a rotational deviation of a seal member with respect to a housing.

According to an illustrative aspect of the present invention, a connector includes a housing configured to be attached to a counterpart member and a seal member configured to be attached to the housing. The housing includes a groove portion, and a protruding portion having an end surface and an outer circumferential surface. The groove portion is configured such that the seal member is attached to the groove portion and extends continuously over a circumferential direction of the housing, the groove portion including a bottom surface, a first side wall provided in a first direction in which the housing is attached to the counterpart member, and a second side wall provided in a second direction being opposite to the first direction. The protruding portion extends from the second side wall toward the first side wall. The end surface faces the first side wall. The outer circumferential surface connects the end surface and the second side wall. A part of the outer circumferential surface has an inclined surface inclined such that a first end of the inclined surface in the first direction is closer to the bottom surface than a second end of the inclined surface in the second direction. The seal member includes an engaging portion configured to, when the seal member is attached to the groove portion, engage with the protruding portion. The engaging portion and the protruding portion are configured to be engaged with each other and to prevent the seal member from moving in the circumferential direction with respect to the housing.

According to another illustrative aspect of the present invention, a connector unit includes a first housing including a mating portion, a second housing including a fitting portion configured such that the mating portion is attached to the fitting portion and a seal member. The second housing includes a groove portion and a protruding portion having an end surface and an outer circumferential surface. The groove portion is provided on the fitting portion, extends continuously over a circumferential direction of the second housing, and is configured such that the seal member is attached to the groove portion. The groove portion includes a bottom surface, a first side wall provided in a first direction in which the second housing is attached to the first housing, and a second side wall provided in a second direction being opposite to the first direction. The protruding portion extends from the second side wall toward the first side wall. The end surface faces the first side wall. The outer circumferential surface connects the end surface and the second side wall. Apart of the outer circumferential surface has a first inclined surface inclined such that a first end of the first inclined surface in the first direction is closer to the bottom surface than a second end of the first inclined surface in the second direction. An end portion of mating portion is configured to, when the first housing and the second housing are attached to each other, face the outer circumferential surface. The seal member includes an engaging portion configured to, when the seal member is attached to the groove portion, engage with the protruding portion. The engaging portion and the protruding portion are configured to be engaged with each other and to prevent the seal member from moving in the circumferential direction with respect to the second housing.

Other aspects and advantages of the invention will be apparent from the following description, the drawings and the claims.

### BRIEF DESCRIPTION OF DRAWINGS

FIG. 1 is a perspective view showing a state where a connector and a counterpart connector in a connector unit according to an embodiment are separated from each other;

FIG. 2 is a perspective view showing a state where the connector and the counterpart connector which are shown in FIG. 1 are fitted to each other;

FIG. 3 is a perspective view showing a state where a seal member is attached to an inner housing;

FIG. 4 is a perspective view showing a state where the inner housing and the seal member are separated from each other;

FIG. 5 is a perspective view showing a mating portion of a counterpart housing of the counterpart connector;

FIG. 6 is a longitudinal cross sectional view showing a state where the connector and the counterpart connector are separated from each other;

FIG. 7 is an enlarged view of a portion B in FIG. 6; and

FIG. 8 is a view corresponding to FIG. 7 in a state where the connector and the counterpart connector are fitted to each other.

### DESCRIPTION OF EMBODIMENTS

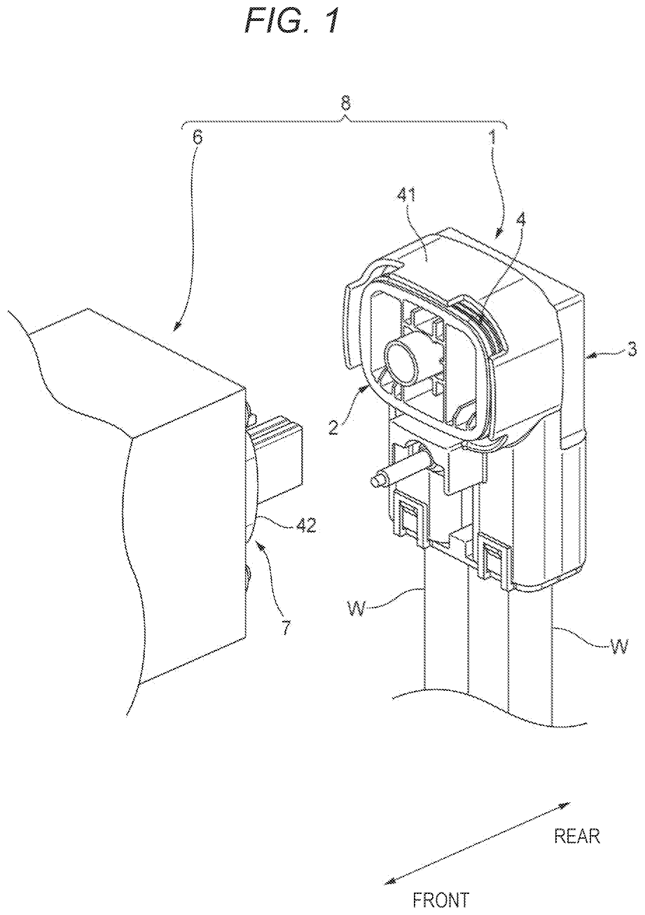

Hereinafter, a connector unit 8 including a connector 1 according to an embodiment shown in FIG. 1 will be described with reference to the drawings. As shown in FIGS. 1 to 4, the connector 1 includes an inner housing 2 (housing, second housing), an outer housing 3 to be fitted to the inner housing 2, and a seal member 4 to be attached to the inner housing 2. The connector 1 has a waterproof function. Hereinafter, for convenience of description, “front-rear direction”, “front”, and “rear” are defined as shown in FIGS. 1 to 4 and FIGS. 6 to 8. The “front-rear direction” is along a direction in which the connector 1 and the inner housing 2 is attached to the counterpart connector 6. Also, a “front” side is also referred as a first side and a “rear” side as a second side. A direction oriented from the second side toward the first side is referred to as a first direction and another direction opposite to the first direction is referred to as a second direction. The first and second directions are thus along the front-rear direction.

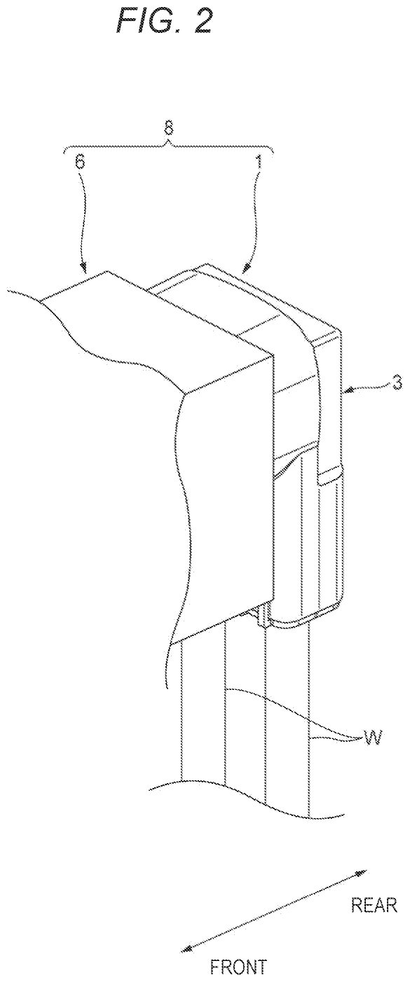

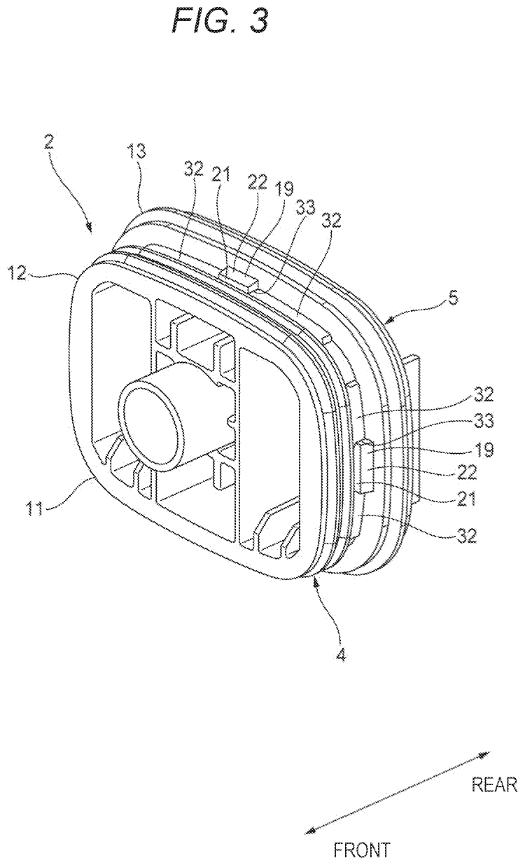

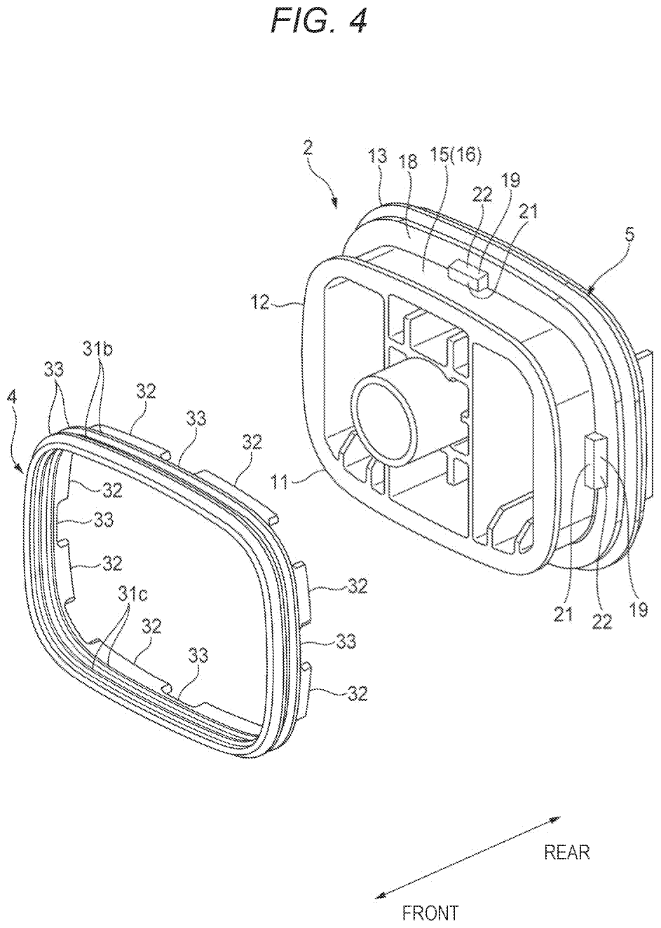

The outer housing 3 formed of resin is fitted to a later-described second fitting portion 13 of the inner housing 2 from a rear side, or toward the first direction (see FIGS. 1, 3, 4 and 6). A counterpart housing 7 (first housing) of the counterpart connector 6 is fitted to a later-described first fitting portion 12 (see FIGS. 3 and 4) of the inner housing 2 from a front side, or toward the second direction, thereby obtaining a connector unit 8 in which the connector 1 and the counterpart connector 6 are fitted to each other (see FIG. 2). Terminals (female terminals, not shown) accommodated in the connector 1 and terminals (male terminals, not shown) accommodated in the counterpart connector 6 are electrically connected to each other. The terminals accommodated in the connector 1 are electrically connected to electric wires W extending from various electrical components and the like. Hereinafter, each member of the connector 1 will be described in order.

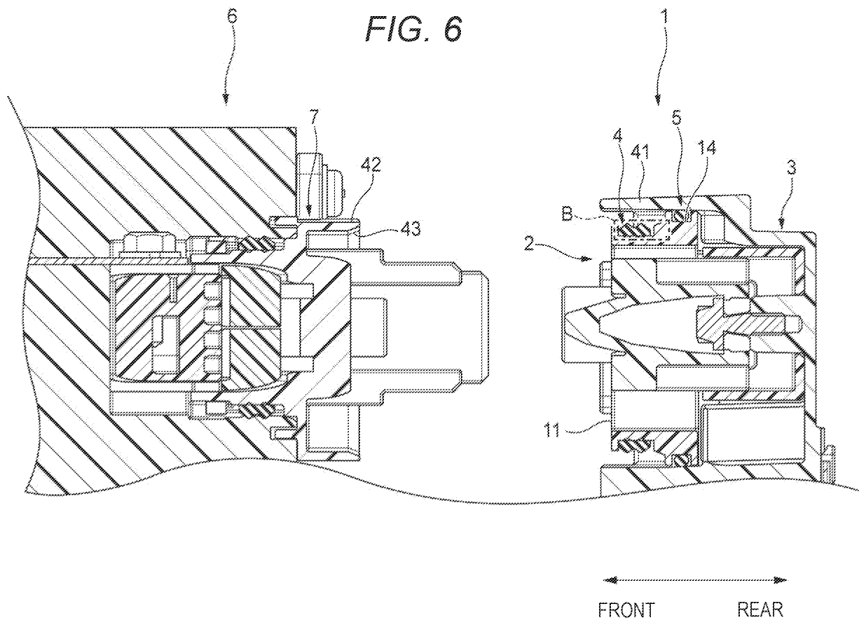

First, the inner housing 2 will be described. As can be understood from FIGS. 4 and 6, the inner housing 2 formed of resin includes a substantially rectangular tubular main body portion 11 extending in the front-rear direction. Hereinafter, for convenience of description, a circumferential direction and a radial direction of the main body portion 11 and the inner housing 2 are simply referred to as a “circumferential direction” and a “radial direction”, respectively.

A front side region of an outer circumference portion of the main body portion 11 forms a first fitting portion 12 to which a mating portion 42 having a substantially rectangular tubular shape (see FIGS. 1, 5 and 6) of the counterpart housing 7 is externally fitted, i.e., the mating portion 42 is attached to the first fitting portion 12 such that the mating portion 42 covers the first fitting portion 12. A rear side region of the outer circumference portion of the main body portion 11 forms a second fitting portion 13 to which a substantially rectangular tubular mating portion 41 (see FIGS. 1 and 6) of the outer housing 3 is externally fitted, i.e., the mating portion 41 is attached to the second fitting portion 13 such that the mating portion 41 covers the second fitting portion 13. The second fitting portion 13 has a larger diameter than that of the first fitting portion 12, and protrudes further outward in the radial direction than the first fitting portion 12 over an entire region in the circumferential direction.

As shown in FIG. 6, an annular groove portion 14 is formed on an outer circumferential surface of the second fitting portion 13. A rubber O-ring 5 is to be mounted to the groove portion 14. In a state where the mating portion 41 of the outer housing 3 is externally fitted to the second fitting portion 13 from a rear side and the inner housing 2 and the outer housing 3 are fitted to each other, as shown in FIG. 6, an inner circumferential surface of the mating portion 41 comes into contact with the O-ring 5 in a pressed manner over the entire region in the circumferential direction, whereby a waterproof function of the O-ring 5 is exhibited.

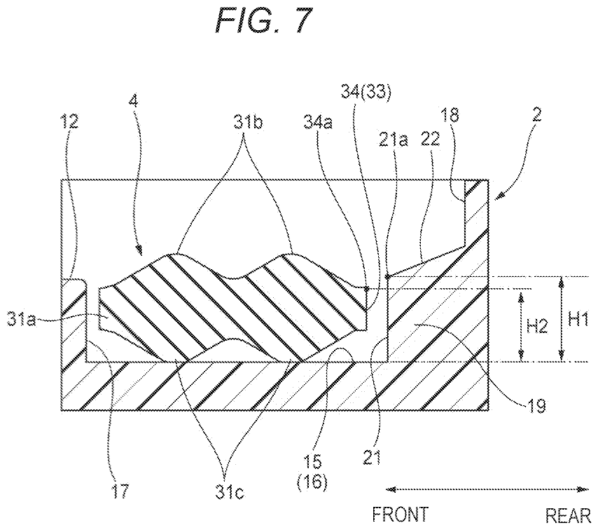

As shown in FIGS. 4 and 6 to 8, a groove portion 15 having an annular shape is formed on the outer circumferential surface of the first fitting portion 12. The seal member 4 is to be mounted to the groove portion 15. As shown in FIG. 7, the groove portion 15 is defined by a bottom surface 16 extending in the circumferential direction and the front-rear direction, a front side surface 17 (first side wall) extending in the circumferential direction and the radial direction, and a rear side surface 18 (second side wall) extending in the circumferential direction and the radial direction, and is open outward in the radial direction. The front side surface 17 and the rear side surface 18 are arranged side by side with each other along a longitudinal direction of the inner housing 2. The front side surface 17 is provided further in the first direction than the rear side surface 18. The front side surface 17 defines an end of the groove portion 15 in the first direction and the rear side surface 18 defines another end of the groove portion 15 in the second direction.

As shown in FIG. 4, at a corner portion defined by the bottom surface 16 and the rear side surface 18 of the groove portion 15, protruding portions 19 extends forward (i.e., in the first direction) from the rear side surface 18 toward the front side surface 17. The protruding portions 19 are formed at a plurality of positions in the circumferential direction. In other words, the protruding portions 19 are provided at an inner corner portion defined by the bottom surface 16 and the rear side surface 18. In this example, as can be understood from FIG. 4, the protruding portions 19 are respectively formed at positions corresponding to central portions of four sides of a rectangular shape of the main body portion 11 in the circumferential direction in the groove portion 15 (four positions in total). Each protruding portion 19 extends forward from the rear side surface 18 up to a predetermined position on the rear half region of the groove portion 15 along the front-rear direction. In other words, a distal end of the protruding portion 19 does not reach a central portion of the groove portion 15 in the front-rear direction. The protruding portions 19 are also continuous with/connected to the bottom surface 16 (see FIG. 7).

As shown in FIG. 7, a front end surface 21 of each protruding portion 19 extends in the circumferential direction and the radial direction. An outer circumferential surface 22 (upper surface) is an outer end surface of each protruding portion 19 in the radial direction. The outer circumferential surface 22 connects the front end surface 21 of the protruding portion 19 and the rear side surface 18 of the groove portion 15. More specifically, a first end 21a of the outer circumferential surface 22, which is an end of the outer circumferential surface 22 in the first direction, is connected to an outer end of the front end surface 21 in the radial direction and a second end of the outer circumferential surface 22, which is another end of the outer circumferential surface 22 in the second direction, is connected to the rear side surface 18. The outer circumferential surface 22 or at least a part of the outer circumferential surface 22 has an inclined surface (first inclined surface) inclined such that the first end of the inclined surface is closer to the bottom surface 16 than the second end of the inclined surface. The second end of the outer circumferential surface 22 is provided in an outer side in the radial direction than the first end 21a of the outer circumferential surface 22. The second end of the outer circumferential surface 22 is provided closer to an opening of the groove portion 15 than the first end 21a of the outer circumferential surface 22.

Next, the seal member 4 will be described. As shown in FIGS. 4, 7 and 9, the seal member 4 is a rubber packing having a substantially rectangular frame shape and an annular shape, and has a shape corresponding to a shape of the groove portion 15. The seal member 4 includes an annular main body portion 31a, two lip portions 31b protruding outward in the radial direction from an outer circumferential surface of the main body portion 31a over the entire region in the circumferential direction, and two lip portions 31c protruding inward in the radial direction from the inner circumferential surface of the main body portion 31a over the entire region in the circumferential direction. The lip portions 31b are formed to be aligned along the front-rear direction. The same applies to the lip portions 31c. An original length of the seal member 4 in the circumferential direction (length when the seal member 4 is not mounted to the inner housing 2) is slightly shorter than a length of the groove portion 15 in the circumferential direction. Therefore, when the seal member 4 is mounted to the groove portion 15, the lip portion 31c on an inner side in the radial direction comes into contact with the bottom surface 16 of the groove portion 15 in a pressed manner due to elastic deformation of the seal member 4.

As shown in FIG. 4, a protruding portion 32 protruding to the rear side, or toward the second direction, is formed on a rear end surface of the seal member 4 over the entire region in the circumferential direction. Recessed portions 33 are respectively formed at positions corresponding to the protruding portions 19 of the groove portion 15 in the circumferential direction of the protruding portion 32 (four positions in total). The recessed portion 33 is recessed such that a part of the protruding portion 32 is cut out. A front side surface 34 (inner wall surface defining a front end of the recessed portion 33, see FIG. 7) of the recessed portion 33 extends in the circumferential direction and the radial direction. In this example, recessed portions similar to the recessed portions 33 are also formed at positions corresponding to four corners of the rectangular shape of the main body portion 11 in the protruding portion 32.

As shown in FIG. 3, the seal member 4 is mounted to the groove portion 15 such that the corresponding protruding portions 19 of the inner housing 2 respectively enter the plurality of recessed portions 33. Accordingly, even when the seal member 4 attempts to be moved relative to the groove portion 15 in the circumferential direction, a side surface of the protruding portion 19 in the circumferential direction and a side surface of the recessed portion 33 in the circumferential direction abut against each other, so that such relative movement is prevented. That is, an interference between the protruding portion 19 and the recessed portion 33 prevents positional deviation of the seal member 4 in the circumferential direction of the inner housing 2.

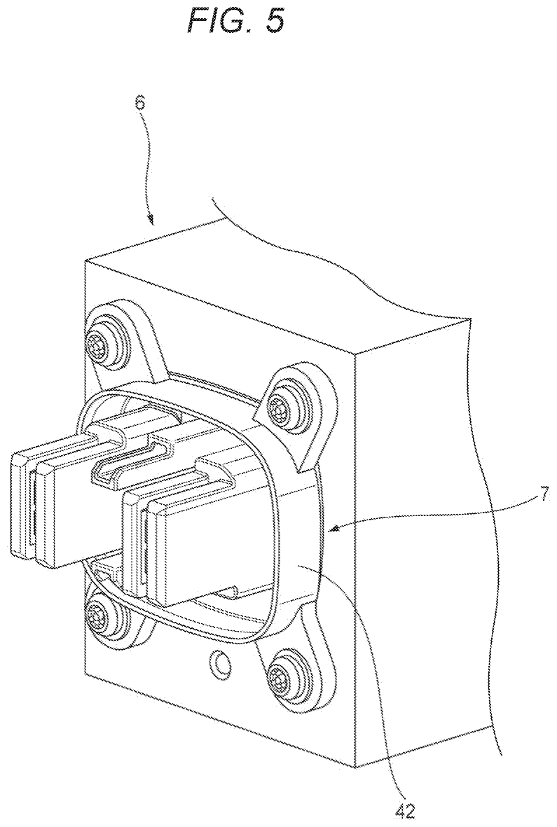

In a state where the seal member 4 is mounted to the groove portion 15, as shown in FIG. 7, the side surface 34 on a rear side (on a right side in FIG. 5) of the main body portion 31a of the seal member 4 and the front end surface 21 of the protruding portion 19 of the groove portion 15 of the inner housing 2 face each other along the front-rear direction. As described above, the side surface 34 is a part of a recessed surface of the recessed portion 33. A relationship of “H1>H2” is established, in which H2 is a distance (height) between a surface (an outer surface) of the main body portion 31a of the seal member 4 (the surface on the upper side of the page of FIG. 7) accommodated in the groove portion 15 and the bottom surface 16 of the groove portion 15 and in which H1 is a distance (height) between a peripheral edge 21a of the front end surface 21 (inclined surface) of the protruding portion 19 of the inner housing 2 on an outer side in the radial direction and the bottom surface 16. In other words, H2 can be described as a distance between an outer peripheral edge 34a of the recessed portion 33 and the bottom surface 16 when the seal member 4 is attached to the groove portion 15. H1 can be described as a distance between the first end 21a of the outer circumferential surface 22 and the bottom surface 16.

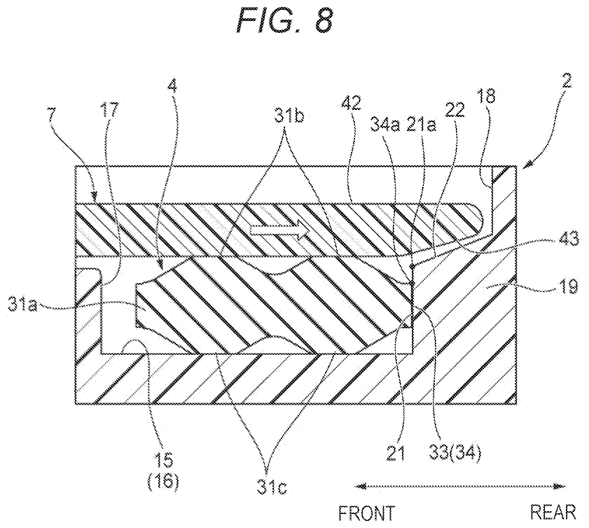

When the connector 1 and the counterpart connector 6 are fitted to each other, the mating portion 42 having a substantially rectangular tubular shape (see FIGS. 5 and 6) of the counterpart housing 7 is externally fitted to the first fitting portion 12 (see FIGS. 3 and 4) of the inner housing 2 from the front side as indicated by an arrow in FIG. 8. When the inner housing 2 and the counterpart housing 7 are fitted to each other, the inner circumferential surface of the mating portion 42 of the counterpart housing 7 comes into contact with the lip portion 31b (see FIG. 7) on an outer circumferential surface side of the seal member 4 in a pressed manner over the entire region in the circumferential direction, and the lip portion 31c on an inner circumferential surface side of the seal member 4 comes into contact with the bottom surface 16 of the groove portion 15 in a pressed manner. As a result, the waterproof function of the seal member 4 is exhibited.

As shown in FIG. 8, a tip end portion (end portion) of the mating portion 42 of the counterpart housing 7 has an inner wall surface 43 (inner surface). The inner wall surface 43 faces the outer circumferential surface 22 of the protruding portion 19 when the connector 1 and the counterpart connector 6 are fitted to each other, and is shaped such that a distance (gap) between the inner wall surface 43 and the outer circumferential surface 22 becomes narrower toward the rear side, i.e., the second direction. For example, the inner wall surface 43 may be a tapered surface shaped such that a thickness of the tip end portion of the mating portion 42 becomes smaller toward the tip end, or toward the second direction. Here, the amount of inclination of the tapered surface may be smaller than the amount of inclination that the outer circumferential surface 22 has such that the gap between the inner wall surface 43 and the outer circumferential surface 22 when the connector 1 and the counterpart connector 6 are fitted to each other becomes narrower toward the second direction.

When the mating portion 42 of the counterpart housing 7 is externally fitted to the first fitting portion 12 of the inner housing 2 from the front side, a rearward external force may be applied to the seal member 4 such that the seal member 4 is pressed toward the front end surface 21 of the protruding portion 19 of the groove portion 15 due to a sliding frictional force or the like between an inner wall surface of the mating portion 42 of the counterpart housing 7 and the lip portion 31b of the seal member 4.

Here, since the outer circumferential surface 22 of the protruding portion 19 and the inner wall surface 43 of the tip end portion of the mating portion 42 of the counterpart housing 7 have the above-described shapes, even when the seal member 4 rides on the protruding portion 19, an external force is to be exerted onto the seal member 4 which pushes back the seal member 4 out of a space between the outer circumferential surface 22 and the inner wall surface 43 of the tip end portion of the mating portion 42 into the groove portion 15. As a result, it is possible to push back the seal member 4 into the groove portion 15 and to prevent a state where the seal member 4 remains on the protruding portion 19 from continuing.

As described above, according to the connector unit 8 including the connector 1 of the present embodiment, since the protruding portion 19 extending from the rear side surface 18 toward the front side surface 17, of the groove portion 15 of the inner housing 2 and the recessed portion 33 of the seal member 4 are fitted to each other, it is possible to prevent the positional deviation of the seal member 4 in the circumferential direction of the inner housing 2. Further, the outer circumferential surface 22 of the protruding portion 19 has an inclined surface inclined such that the first end of the outer circumferential surface 22 in the first direction is closer to the bottom surface 16 than the second end of the outer circumferential surface 22 in the second direction. In addition, the inner wall surface 43 of the tip end portion of the mating portion 42 of the counterpart housing 7 is configured to, when the connector 1 and the counterpart connector 6 are fitted to each other, face the outer circumferential surface 22 of the protruding portion 19 with the gap between the outer circumferential surface 22 and the inner wall surface 43 decreasing toward the rear side. When the counterpart housing 7 and the inner housing 2 are fitted to each other, an external force may be applied to the seal member 4 which pushes the seal member 4 toward the front end surface 21 of the protruding portion 19. At this time, since the outer circumferential surface 22 of the protruding portion 19 and the inner wall surface 43 of the tip end portion of the mating portion 42 have the above-described shapes, the external force is to be exerted on the seal member 4 which pushes back the seal member 4 out from the space between the outer circumferential surface 22 and the inner wall surface 43 of the tip end portion of the mating portion 42 even when the pressed seal member 4 rides on the protruding portion 19. As a result, it is possible to prevent a state where the seal member 4 rides and remains on the protruding portion 19 from being maintained. Therefore, in the connector unit 8 according to the present embodiment, proper connector fitting can be performed while preventing the rotational deviation of the seal member 4 with respect to the inner housing 2.

While the present invention has been described with reference to certain exemplary embodiments thereof, the scope of the present invention is not limited to the exemplary embodiments described above, and it will be understood by those skilled in the art that various changes and modifications may be made therein without departing from the scope of the present invention as defined by the appended claims.

In the above embodiment, the protruding portions 19 are formed at a plurality of positions (specifically, four positions) of the groove portion 15 of the inner housing 2 in the circumferential direction. However, the protruding portion 19 may be formed at only one position of the groove portion 15 of the inner housing 2 in the circumferential direction.

Further, in the above-described embodiment, the outer circumferential surface 22 of the protruding portion 19 has an inclined surface inclined such that the first end of the outer circumferential surface 22 in the first direction is closer to the bottom surface 16 than the second end of the outer circumferential surface 22 in the second direction. Alternatively, only a part of the outer circumferential surface 22 of the protruding portion 19 in the circumferential direction or only a part of the outer circumferential surface 22 in the front-rear direction may have the above-described inclined shape, and the remaining part of the outer circumferential surface 22 may be a surface extending parallel to the front-rear direction or to the bottom surface 16.

Further, in the above embodiment, the distance (height) H2 between the outer peripheral edge 34a of the recessed portion 33 of the seal member 4 in the radial direction and the bottom surface 16 of the groove portion 15 is shorter than the distance (height) H1 between the outer peripheral edge 21a of the front end surface 21 (inclined surface) of the protruding portion 19 of the inner housing 2 in the radial direction and the bottom surface 16 (H1>H2). In contrast, the distances H2 and H1 may be the same distance (H1=H2), or the distance H2 may be longer than H1 (H1>H2).

Further, in the above-described embodiment, the front end surface 21 of the protruding portion 19 extends in the radial direction perpendicular to the front-rear direction (see FIG. 7). However, a part or all of the front end surface 21 of the protruding portion 19 may be an inclined surface (second inclined surface) inclined such that an outer end of the inclined surface 21 in the radial direction of the second housing 2 is closer to the first side wall 17 than an inner end of the inclined surface 21 in the radial direction. In this case, it is preferable that the distance (height) H2 between the outer peripheral edge 34a of the recessed portion 33 of the seal member 4 in the radial direction and the bottom surface 16 of the groove portion 15 is shorter than the distance (height) H1 between the outer peripheral edge 21a of the front end surface 21 (inclined surface) of the protruding portion 19 of the inner housing 2 in the radial direction and the bottom surface 16.

Due to the end surface 21 of the protruding portion 19 being the inclined surface as described above and the height H1 being longer than the height H2, when the side surface 34 of the recessed portion 33 of the seal member 4 is pressed against the front end surface 21 by the rearward external force described above, the reaction force exerted on the side surface 34 of the recessed portion 33 by the front end surface 21 is directed toward the bottom surface 16 side (inner side in the radial direction) of the groove portion 15. Further, the seal member 4 is pushed so that the side surface 34 approaches the bottom surface 16. As a result, it is possible to further prevent the seal member 4 from riding on the protruding portion 19.

Further, in the above embodiment, the inner wall surface 43 of the tip end portion of the mating portion 42 of the counterpart housing 7 has the surface shaped such that a gap between the inner wall surface 43 and the outer circumferential surface 22 of the protruding portion 19 decreases toward the rear side. However, the inner wall surface 43 may have the surface shape in which, when the connector 1 and the counterpart connector 6 are fitted to each other, the gap between the inner wall surface 43 and the outer circumferential surface 22 is uniform/consistent/the same at any positions along the front-rear direction. Even when the distance between the inner wall surface 43 and the outer circumferential surface 22 is uniform, the external force can be exerted on the seal member 4 which pushes back the seal member 4 out from the space between the outer circumferential surface 22 and the inner wall surface 43 since the outer circumferential surface 22 itself has the shape inclined toward the bottom surface 16 of the groove portion 15.

Further, in the above embodiment, the two lip portions 31b are provided on the outer peripheral surface side of the seal member 4, and the two lip portions 31c are provided on the inner circumferential surface of the seal member 4. However, only one lip portion 31b may be provided on the outer circumferential surface side of the seal member 4, or three or more lip portions 31b may be provided on the outer circumferential surface side of the seal member 4. The same applies to the lip portion 31c on the inner circumferential surface side of the seal member 4. Further, the seal member 4 may have only the lip portion 31b on the outer circumferential surface side without having the lip portion 31c on the inner circumferential surface side.

Further, in the above embodiment, the groove portion 15 to which the seal member 4 is mounted includes the bottom surface 16, the front side surface 17, and the rear side surface 18 as parts of the inner housing 2 itself. On the other hand, when a component (for example, a front holder) separately provided from the inner housing 2 is attached to the inner housing 2, the groove portion 15 may be formed by the component and the inner housing 2. As an example, when a separate front holder is attached to the inner housing 2 from a front side, a part of the front holder may be used as the front side surface 17, and the groove portion 15 may include a part thereof, and the bottom surface 16 and the rear side surface 18 of the inner housing 2.

According to an aspect of the embodiments described above, a connector unit (8) includes a first housing (for example, a counterpart housing 7) including a mating portion (42), a second housing (for example, an inner housing 2) including a fitting portion (12) configured such that the mating portion (42) is attached to the fitting portion (12) and a seal member (4). The second housing (2) includes a groove portion (15) and a protruding portion (19) having an end surface (for example, a front end surface 21) and an outer circumferential surface (22). The groove portion (15) is provided on the fitting portion (12), extends continuously over a circumferential direction of the second housing (2), and is configured such that the seal member (4) is attached to the groove portion (15). The groove portion (15) includes a bottom surface (16), a first side wall (for example, a front side surface 17) provided in a first direction in which the second housing (2) is attached to the first housing (7), and a second side wall (18) provided in a second direction being opposite to the first direction. The protruding portion (19) extends from the second side wall (for example, a rear side surface 18) toward the first side wall (17). The end surface (21) faces the first side wall (17). The outer circumferential surface (22) connects the end surface (21) and the second side wall (18). Apart of the outer circumferential surface (22) has a first inclined surface (22) inclined such that a first end (21a) of the first inclined surface (22) in the first direction is closer to the bottom surface (16) than a second end of the first inclined surface (22) in the second direction. An end portion (for example, an inner wall surface 43) of the mating portion (42) is configured to, when the first housing (7) and the second housing (2) are attached to each other, face the outer circumferential surface (22). The seal member (4) includes an engaging portion (33) configured to, when the seal member (4) is attached to the groove portion (15), engage with the protruding portion (19). The engaging portion (33) and the protruding portion (19) are configured to be engaged with each other and to prevent the seal member (4) from moving in the circumferential direction with respect to the second housing (2).

The end portion (43) of the mating portion (42) may have a surface having a shape in which, when the first housing (7) and the second housing (2) are attached to each other, a gap between the end portion (43) and the outer circumferential surface (22) becomes narrower toward the second direction.

The end portion (43) of the mating portion (42) may have a surface having a shape in which, when the first housing (7) and the second housing (2) are attached to each other, a gap between the end portion (43) and the outer circumferential surface (22) is uniform along the second direction.

According to the connector unit having the above described configuration, at least one protruding portion extending from the side surface of the second housing on the back side in the fitting direction toward the side surface of the housing on the front side in the fitting direction and the engaging portion of the seal member are fitted to each other, so that it is possible to prevent the positional deviation of the seal member in the circumferential direction of the second housing. Further, at least a part of the outer circumferential surface of the protruding portion has a shape that is inclined so as to approach the opening of the groove portion from the bottom surface as the shape extends from the extending end surface toward the side surface of the groove portion on the back side in the fitting direction. In addition, the end portion of the mating portion of the first housing includes the surface shape that faces the outer circumferential surface of the protruding portion, and in which the distance between the end portion and the outer circumferential surface becomes narrower toward the back side in the fitting direction, or the surface shape in which the distance between the end portion and the outer circumferential surface is uniform regardless of the position in the fitting direction. Therefore, when the first housing and the second housing are fitted to each other, even when the pressed seal member rides on the protruding portion, such an external force is exerted on the seal member so as to push the seal member out from the space between the outer circumferential surface and the end portion of the mating portion toward the groove. As a result, the seal member is prevented from riding on the protruding portion. Therefore, the connector unit having this configuration enables proper connector fitting while preventing the rotational deviation of the seal member with respect to the second housing.

At least a part of the end surface (21) may have a second inclined surface (21) inclined such that an outer end of the second inclined surface (21) in a radial direction of the second housing (2) is closer to the first side wall (17) than an inner end of the second inclined surface (21) in the radial direction.

With this configuration, at least a part of the extending end surface of the protruding portion of the second housing has the inclined surface that is inclined so as to approach the side surface of the groove portion on the front side as the inclined surface extends from the bottom surface of the groove portion toward the opening. Therefore, when the counterpart member is inserted into the second housing, such an external force may be exerted on the seal member so as to press the seal member toward the extending end surface of the protruding portion. At this time, the extending end surface has the above-described inclined surface, and a height of an end portion of the inclined surface on the opening side (hereinafter, referred to as an “inclined surface end portion”) from the bottom surface of the groove portion is higher than a height of an end portion of the seal member on the extending end surface side on the opening side (hereinafter referred to as “seal member end portion”) from the bottom surface of the groove portion. Therefore, when the seal member is pressed by the inclined surface, the reaction force exerted on the seal member by the inclined surface is directed to a bottom surface side of the groove portion. As a result, the seal member is more appropriately prevented from riding on the protruding portion.

According to another aspect of the embodiments described above, a connector (1) includes a housing (2) configured to be attached to a counterpart member (7) and a seal member (4) configured to be attached to the housing (2). The housing (2) includes a groove portion (15), and a protruding portion (19) having an end surface (21) and an outer circumferential surface (22). The groove portion (15) is configured such that the seal member (4) is attached to the groove portion (15) and extends continuously over a circumferential direction of the housing (2), the groove portion (15) including a bottom surface (16), a first side wall (17) provided in a first direction in which the housing (2) is attached to the counterpart member (7), and a second side wall (18) provided in a second direction being opposite to the first direction. The protruding portion (19) extends from the second side wall (18) toward the first side wall (17). The end surface (21) faces the first side wall (17). The outer circumferential surface (22) connects the end surface (21) and the second side wall (18). Apart of the outer circumferential surface (22) has an inclined surface (22) inclined such that a first end (21a) of the inclined surface (22) in the first direction is closer to the bottom surface (16) than a second end of the inclined surface (22) in the second direction. The seal member (4) includes an engaging portion (33) configured to, when the seal member (4) is attached to the groove portion (15), engage with the protruding portion (19). The engaging portion (33) and the protruding portion (19) are configured to be engaged with each other and to prevent the seal member (4) from moving in the circumferential direction with respect to the housing (2).

According to the connector having the above described configuration, at least one protruding portion extending from the side surface of the housing on the back side in the fitting direction toward the side surface of the housing on the front side in the fitting direction and the engaging portion of the seal member are fitted to each other, so that it is possible to prevent the positional deviation of the seal member in the circumferential direction of the housing. Further, at least a part of the outer circumferential surface of the protruding portion has a shape that is inclined so as to approach the opening of the groove portion from the bottom surface as the shape extends from the extending end surface toward the side surface of the groove portion on the back side in the fitting direction. Therefore, when the housing and the counterpart member are fitted to each other, even when the pressed seal member rides on the protruding portion, such an external force is exerted on the seal member so as to push the seal member out from the space between the outer circumferential surface and the end portion of the mating portion toward the groove. From the viewpoint of generating such an external force, it is preferable that the end portion of the mating portion of the counterpart member has a surface shape that faces the outer circumferential surface of the protruding portion, and in which a distance between the end portion and the outer circumferential surface becomes narrower toward the back side in the fitting direction, or a surface shape in which a distance between the end portion and the outer circumferential surface is uniform regardless of a position in the fitting direction. As a result, the seal member can be prevented from riding on the protruding portion. Therefore, the connector having this configuration enables proper connector fitting while preventing the rotational deviation of the seal member with respect to the housing.

What is claimed is:

1. A connector unit comprising:
a first housing including a mating portion;
a second housing including a fitting portion configured such that the mating portion is attached to the fitting portion; and
a seal member,
wherein the second housing includes a groove portion and a protruding portion having an end surface and an outer circumferential surface;
wherein the groove portion is provided on the fitting portion, extends continuously over a circumferential direction of the second housing, and is configured such that the seal member is attached to the groove portion, the groove portion including a bottom surface, a first side wall provided in a first direction in which the second housing is attached to the first housing, and a second side wall provided in a second direction being opposite to the first direction;
wherein the protruding portion extends from the second side wall toward the first side wall;
wherein the end surface faces the first side wall;
wherein the outer circumferential surface connects the end surface and the second side wall, a part of the outer circumferential surface having a first inclined surface inclined such that a first end of the first inclined surface in the first direction is closer to the bottom surface than a second end of the first inclined surface in the second direction;
wherein an end portion of the mating portion is configured to, when the first housing and the second housing are attached to each other, face the outer circumferential surface;
wherein the seal member includes an engaging portion configured to, when the seal member is attached to the groove portion, engage with the protruding portion; and
wherein the engaging portion and the protruding portion are configured to be engaged with each other and to prevent the seal member from moving in the circumferential direction with respect to the second housing.

2. The connector unit according to claim 1,
wherein the end portion of the mating portion has a surface having a shape in which, when the first housing and the second housing are attached to each other, a gap between the end portion and the outer circumferential surface becomes narrower toward the second direction.

3. The connector unit according to claim 1,
wherein the end portion of the mating portion has a surface having a shape in which, when the first housing and the second housing are attached to each other, a gap between the end portion and the outer circumferential surface is uniform along the second direction.

4. The connector unit according to claim 1,
wherein at least a part of the end surface has a second inclined surface inclined such that an outer end of the second inclined surface in a radial direction of the second housing is closer to the first side wall than an inner end of the second inclined surface in the radial direction.

5. A connector comprising:
a housing configured to be attached to a counterpart member; and
a seal member configured to be attached to the housing,
wherein the housing includes a groove portion, and a protruding portion having an end surface and an outer circumferential surface;
wherein the groove portion is configured such that the seal member is attached to the groove portion and extends continuously over a circumferential direction of the housing, the groove portion including a bottom surface, a first side wall provided in a first direction in which the housing is attached to the counterpart member, and a second side wall provided in a second direction being opposite to the first direction;
wherein the protruding portion extends from the second side wall toward the first side wall;
wherein the end surface faces the first side wall;
wherein the outer circumferential surface connects the end surface and the second side wall, a part of the outer circumferential surface having an inclined surface inclined such that a first end of the inclined surface in the first direction is closer to the bottom surface than a second end of the inclined surface in the second direction;
wherein the seal member includes an engaging portion configured to, when the seal member is attached to the groove portion, engage with the protruding portion; and
wherein the engaging portion and the protruding portion are configured to be engaged with each other and to prevent the seal member from moving in the circumferential direction with respect to the housing.
